(19) United States
(12) Patent Application Publication
(10) Pub. No.: US 2025/0317420 A1
(43) Pub. Date: Oct. 9, 2025

(54) SECURITY FABRIC PLATFORM NETWORK SERVICES ARCHITECTURE AND FUNCTIONALITIES

(71) Applicant: Level 3 Communications, LLC, Denver, CO (US)

(72) Inventors: Mark Alan RAMACH, Seattle, WA (US); Bobby W. METZ, Johnson City, TN (US); Robert A. STENGER, Collinsville, IL (US); Kenneth L. SEXTON, Castle Rock, CO (US); Brian J. BOEVINGLOH, Ballwin, MO (US); Aravind Kumar SELVARAJ, Englewood, CO (US); Michael F. ROBLES, Arvada, CO (US); Gurpreet S. SIDHU, Aurora, CO (US)

(73) Assignee: Level 3 Communications, LLC, Denver, CO (US)

(21) Appl. No.: 19/086,419

(22) Filed: Mar. 21, 2025

Related U.S. Application Data
(60) Provisional application No. 63/573,774, filed on Apr. 3, 2024.

(51) Int. Cl. H04L 9/40; H04L 41/40

(52) U.S. Cl. CPC H04L 63/0236; H04L 41/40; H04L 63/1458

(57) ABSTRACT

Novel tools and techniques are provided for implementing security fabric platform network services architecture and functionalities. In various embodiments, at least one VM among a plurality of virtual machines (“VMs”) that is hosted on a security fabric platform includes dual network interface controllers (“NICs”) or virtual NICs (“VNICs”). A request to perform a set of tasks may be routed to a VM of the plurality of VMs via one of the NICs or VNICs. Two or more VMs and/or one or more containers hosted on the security fabric platform and/or on one or more worker nodes may be service chained from one to another of the NICs or VNICs of the VMs and/or containers. Results of the set of tasks as processed by virtual or cloud-native network functions may be routed via a firewall, via network address translation, from and to a destination network address associated with a destination device.

### CROSS-REFERENCE TO RELATED APPLICATIONS

This application claims the benefit of U.S. Provisional Application No. 63/573,774 filed Apr. 3, 2024, entitled “Security Fabric Platform Network Services Architecture and Functionalities,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network service ordering and provisioning, and, more particularly, to methods, systems, and apparatuses for implementing security fabric platform network services architecture and functionalities.

### BACKGROUND

Transmitting network traffic into a cluster of virtual machines (“VMs”) or containers traditionally requires one or more node ports on each network node. In some cases, between 20 and 50 node ports may be required per customer, with these ports being open on every single compute node in the cluster. As the number of customers increases, the number of ports that are required increases proportionately or exponentially. In such cases, issues with scalability arise. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIGS. 1A and 1B depict schematic diagrams illustrating an example system for implementing security fabric platform network services architecture and functionalities, in accordance with various embodiments.

FIG. 2 depicts a schematic diagram illustrating another example system for implementing security fabric platform network services architecture and functionalities, in accordance with various embodiments.

FIGS. 3A-3C depict flow diagrams illustrating an example method for implementing security fabric platform network services architecture and functionalities, in accordance with various embodiments.

FIG. 4 depicts a flow diagram illustrating another example method for implementing security fabric platform network services architecture and functionalities, in accordance with various embodiments.

FIG. 5 depicts a flow diagram illustrating yet another example method for implementing security fabric platform network services architecture and functionalities, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing network service ordering and provisioning, and, more particularly, to methods, systems, and apparatuses for implementing security fabric platform network services architecture and functionalities.

In various embodiments, a security fabric platform, which is disposed on a first server among one or more servers in a first network, includes a plurality of virtual machines (“VMs”) that is hosted on the security fabric platform. At least one VM among the plurality of VMs includes a first network interface controller (“NIC”) or a first virtual NIC (“VNIC”) and a second NIC or VNIC. In some examples, a computing system is configured to perform one or more operations. In examples, the one or more operations includes receiving a first request to perform a set of tasks, the first request including data associated with the set of tasks. In response to receiving the first request, the first request is routed to a first VM among the plurality of VMs via the first NIC or VNIC, in some cases, via the firewall and using the NAT device and one or more translation tables. The computing system service chains one or more second VMs among the plurality of VMs via the second NIC or VNIC of one VM and via the first NIC or VNIC of the next VM in the service chain. A first virtual network function (“VNF”) that is instantiated on each of the first VM and the one or more second VMs is caused to perform a portion of the set of tasks. Results of the set of tasks are sent to a destination network address associated with a destination device, in some cases, via the firewall and the NAT device.

In some cases, service chaining may extend through one or more security fabric platform worker nodes via a rack switch, each security fabric platform worker node being disposed on a second server among the one or more servers in the first network. Each security fabric platform worker node hosts at least one of one or more single-NIC VMs, one or more dual-NIC VMs, or one or more containers, and/or the like. While VNFs may be deployed, instantiated, and/or implemented on VMs, cloud-native network functions (“CNFs”) may be deployed, instantiated, and/or implemented on containers. With the service chaining and NAT routing, any suitable number of VMs and/or containers may be linked in the service chain via the NICs/VNICs, via the CNI ports, rack switches, and one or more worker nodes, and/or the like. In this manner, any number of VNFs and/or CNFs may be deployed, instantiated, and/or implemented on VMs and/or containers that are hosted on the security fabric platform and the one or more worker nodes, and any suitable number among the plurality of such VMs and containers may be service chained, thereby resulting in high scalability. In some embodiments, (“SASE”)-based network services VNFs may be ordered, deployed, and configured on one or more of these VMs and/or containers in the security fabric platform and/or at least one worker node, thereby facilitating provisioning of network security provisioning.

These and other aspects of the security fabric platform network services architecture and functionalities are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system, a first request to perform a set of tasks; and in response to receiving the first request, routing, by the computing system, the first request to at least one of a security fabric platform disposed on a first server among one or more servers in a first network or a first virtual machine (“VM”) among a plurality of VMs that is hosted on the security fabric platform. The first VM including a first network interface controller (“NIC”) or a first virtual NIC (“VNIC”) and a second NIC or VNIC. The method also includes sending, by the computing system, data associated with the set of tasks to the first VM via the first NIC or VNIC of the first VM; causing, by the computing system, a first virtual network function (“VNF”) that is instantiated on the first VM to perform a first task among the set of tasks, based on at least one of the first request or the data; and sending, by the computing system, at least one of the first request, the data, results of the first task, or a second request to perform a second task among the set of tasks to a third NIC or VNIC of a second VM among the plurality of VMs, in a service chain via the second NIC or VNIC of the first VM. The method further includes causing, by the computing system, a second VNF that is instantiated on the second VM to perform the second task, based on the at least one of the first request, the data, the results of the first task, or the second request; and sending, by the computing system, results of the set of tasks to a destination network address associated with a destination device.

In some embodiments, the first request includes the data, and routing the first request and sending the data to the first VM are performed together in a single process. In some examples, the first request is received by a firewall. In examples, the first request is routed directly from the firewall to the at least one of the security fabric platform or the first VM, using a network address translation (“NAT”) device and one or more translation tables.

In an example, the firewall and the NAT device are part of at least one of the security fabric platform or the first server. In some examples, the first request is received at a first port of the first server. In response to the firewall allowing the first request to pass to the first VM, the NAT device routes the first request from the firewall to the first VM. The results of the set of tasks are sent to the destination network address over the first network and a second network via a second port of the first server, based on a network translation of the destination network address.

In another example, the firewall and the NAT device are part of the first network yet external to the first server. In examples, the NAT device routes the first request from the firewall to the at least one of the security fabric platform or the first VM via a first port of the first server. The results of the set of tasks are sent to the destination network address over the first network and a second network via a second port of the second server and via the firewall, based on a network translation of the destination network address by the NAT device.

In examples, the firewall is a multi-tenant firewall. The multi-tenant firewall is configured to block bad actor IP addresses that are contained in a list that is compiled in a threat feed that is created and collected by a rapid threat defense service system.

In some examples, the plurality of VMs further includes a third VM. The method further includes sending, by the computing system, at least one of the first request, the data, the results of the first task, the second request, results of the second task, or a third request to perform a third task among the set of tasks to a fifth NIC or VNIC of the third VM, in the service chain via a fourth NIC or VNIC of the second VM. The method further includes causing, by the computing system, a third VNF that is instantiated on the third VM to perform the third task, based on the at least one of the first request, the data, the results of the first task, the second request, the results of the second task, or the third request. In examples, sending the results of the set of tasks includes sending, by the computing system, at least one of the results of the first task, the results of the second task, or results of the third task to the destination network, via a sixth NIC or VNIC of the third VM.

In examples, the method further includes sending, by the computing system, at least one of the first request, the data, the results of the first task, the second request, results of the second task, or a fourth request to perform one or more fourth tasks among the set of tasks to one or more security fabric platform worker nodes, via at least one of the second NIC or VNIC of the first VM or the third NIC or VNIC of the second VM, via at least one container network interface (“CNI”), via a third port of the first server, and via a rack switch. The method further includes causing, by the computing system, one or more fourth VNFs or one or more cloud-native network functions (“CNFs”) that are instantiated on at least one of one or more single-NIC VMs, one or more dual-NIC VMs, or one or more containers that are hosted on each of the one or more security fabric platform worker nodes to perform the one or more fourth tasks. The method further includes sending, by the computing system, results of the one or more fourth tasks to the first VM or the second VM, via the rack switch, via the at least one CNI, via the third port of the first server, and via the at least one of the second NIC or VNIC of the first VM or the third NIC or VNIC of the second VM. In some cases, sending the results of the set of tasks includes sending, by the computing system, at least one of the results of the first task, the results of the second task, or results of the one or more fourth tasks to the destination network, via a fourth NIC or VNIC of the second VM. In some instances, the service chain is configured or reconfigured to span any of the one or more security fabric platform worker nodes via the rack switch and via the CNI, where one or more VNFs or one or more CNFs are deployed on the one or more security fabric platform worker nodes.

In some examples, the first and second VNFs are secure access service edge (“SASE”)-based network services VNFs. In such examples, the method further includes, in response to receiving a request to deploy and configure one or more SASE-based network services among a plurality of network services provided by a service provider, deploying and configuring the first and second VNFs in the respective first and second VMs of the security fabric platform. In examples, the first and second VNFs are among a plurality of VNFs. In some cases, the plurality of VNFs each includes one of a multi-tenant firewall VNF, a next-generation firewall (“NGFW”) VNF, an Internet and Cloud intelligence platform VNF, a distributed denial of service (“DDoS”) scrubber VNF, or a software-defined wide area network (“SD-WAN”) VNF, and/or the like. In some instances, the security fabric platform is deployed in one of a cloud environment, a data center, or physical equipment disposed at customer premises, and/or the like.

In another aspect, the technology relates to a system, including a multi-tenant firewall configured to monitor and filter network traffic; a network address translation (“NAT”) device configured to map an Internet Protocol (“IP”) address space into another by modifying network address information in the IP header of packets while the packets pass through the NAT device; a security fabric platform disposed on a first server among one or more servers in a first network. The security fabric platform includes a plurality of virtual machines (“VMs”) that is hosted on the security fabric platform, at least one VM among the plurality of VMs includes a first network interface controller (“NIC”) or a first virtual NIC (“VNIC”) and a second NIC or VNIC; and a computing system configured to perform one or more operations. In examples, the one or more operations includes receiving a first request to perform a set of tasks, the first request including data associated with the set of tasks; in response to receiving the first request, routing the first request to a first VM among the plurality of VMs via the first NIC or VNIC, via the firewall and using the NAT device and one or more translation tables; service chaining one or more second VMs among the plurality of VMs via the second NIC or VNIC of one VM and via the first NIC or VNIC of the next VM in the service chain; causing a first virtual network function (“VNF”) that is instantiated on each of the first VM and the one or more second VMs to perform a portion of the set of tasks; and sending results of the set of tasks to a destination network address associated with a destination device, via the firewall and the NAT device.

In some examples, the computing system includes at least one of an orchestrator, a security fabric platform manager, a server manager, a cloud computing system, or a distributed computing system, and/or the like. In an example, the firewall and the NAT device are part of at least one of the security fabric platform or the first server. In some instances, the first request is received at a first port of the first server. In some cases, in response to the firewall allowing the first request to pass to the first VM, the NAT device routes the first request from the firewall to the first VM. In examples, the results of the set of tasks are sent to the destination network address over the first network and a second network via a second port of the first server, based on a network translation of the destination network address.

In another example, the firewall and the NAT device are part of the first network yet external to the first server. In some instances, the NAT device routes the first request from the firewall to the at least one of the security fabric platform or the first VM via a first port of the first server. In some cases, the results of the set of tasks are sent to the destination network address over the first network and a second network via a second port of the second server and via the firewall, based on a network translation of the destination network address by the NAT device.

In examples, the system further includes a rack switch; and one or more security fabric platform worker nodes. Each security fabric platform worker node is disposed on a second server among the one or more servers in the first network. In some instances, each security fabric platform worker node hosts at least one of one or more single-NIC VMs, one or more dual-NIC VMs, or one or more containers, and/or the like. In some examples, the one or more operations further include service chaining at least one security fabric platform worker node among the one or more security fabric platform worker nodes to the first VM via its second NIC or VNIC or to one of the one or more second VMs via its first NIC or VNIC, further via the rack switch, via at least one container network interface (“CNI”), and via a third port of the first server. The one or more operations further include causing one or more second VNFs or one or more CNFs that are instantiated on the at least one of the one or more single-NIC VMs, the one or more dual-NIC VMs, or the one or more containers to perform addition portions of the set of tasks. The one or more operations further include sending results of the additional portions of the set of tasks to the first VM or the one of the one or more second VMs, via the rack switch, via the at least one CNI, via the third port of the first server, and via the second NIC or VNIC of the first VM or the first NIC or VNIC of the one of the one or more second VMs.

In yet another aspect, the technology relates to a computer-implemented method, including receiving a request to deploy and configure one or more secure access service edge (“SASE”)-based network services among a plurality of network services provided by a service provider. The one or more SASE-based network services collectively include a set of unified, cloud-based services that integrate software-defined wide area network (“SD-WAN”) functionalities with network service functionalities and network security functionalities. The method further includes autonomously orchestrating deployment and configuration of one or more SASE-based network services virtual network function (“VNF”) on one or more virtual machines (“VMs”) that are hosted on the security fabric platform that is disposed on a first server among a plurality of servers in a first network. In examples, at least one VM among the plurality of VMs includes a first network interface controller (“NIC”) or a first virtual NIC (“VNIC”) and a second NIC or VNIC.

In some examples, the one or more SASE-based network services VNFs each includes one of a multi-tenant firewall VNF, a next-generation firewall (“NGFW”) VNF, an Internet and Cloud intelligence platform VNF, a distributed denial of service (“DDoS”) scrubber VNF, or a software-defined wide area network (“SD-WAN”) VNF, and/or the like. In examples, the method further includes configuring or reconfiguring a service chain to span, via a rack switch and via at least one container network interface (“CNI”), the one or more VMs of the security fabric platform and at least one of one or more single-NIC VMs, one or more dual-NIC VMs, or one or more containers, and/or the like, that are hosted on each of one or more security fabric platform worker nodes.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

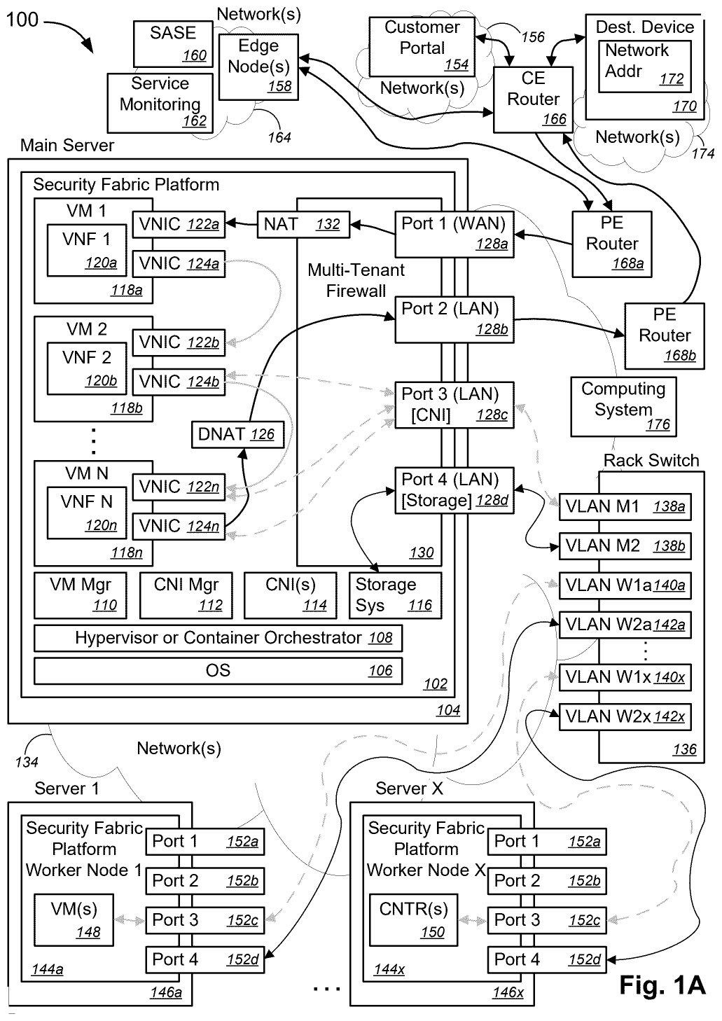

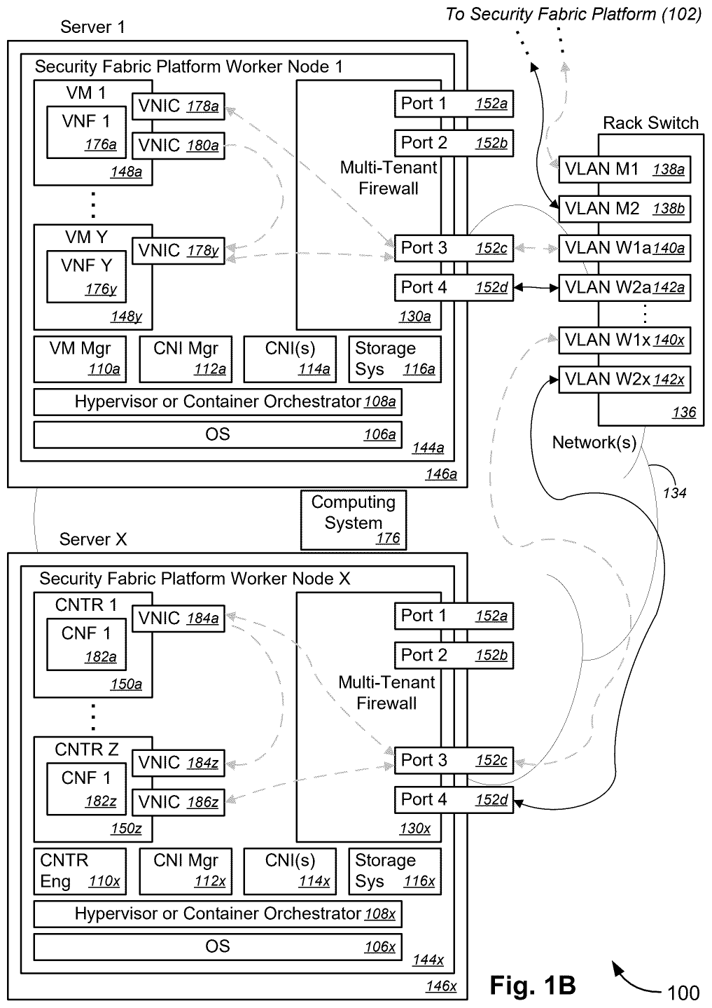

We now turn to the embodiments as illustrated by the drawings. FIGS. 1-6 illustrate some of the features of the method, system, and apparatus for implementing network service ordering and provisioning, and, more particularly, to methods, systems, and apparatuses for implementing security fabric platform network services architecture and functionalities, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIGS. 1A and 1B (collectively, “FIG. 1”) depict schematic diagrams illustrating an example system 100 for implementing security fabric platform network services architecture and functionalities, in accordance with various embodiments.

In the non-limiting embodiment of FIG. 1A, system 100 includes a security fabric platform 102 that is disposed on a main server 104 among a plurality of servers in a first network 134. The security fabric platform 102 includes an operating system (“OS”) or host OS 106, a hypervisor or container orchestrator 108, and at least one of a virtual machine (“VM”) manager 110, a container network interface (“CNI”) manager 112, at least one CNI 114, or a storage system 116, and/or the like. The security fabric platform 102 further includes a plurality of VMs 1 through N 118a-118n (collectively, “VMs 118” or the like) that is hosted on the security fabric platform 102, and a plurality of virtual network functions (“VNFs”) 1 through N 120a-120n (collectively, “VNFs 120” or the like) that is deployed, instantiated, and/or implemented on the corresponding plurality of VMs 118a-118n, and/or the like. Each of at least one VM 118 among the plurality of VMs 118a-118n is a dual-network interface controller (“NIC”) VM, while other VMs among the plurality of VMs 118a-118n are single-NIC VMs. While FIG. 1A depicts VMs 118a, 118b, and 118n as dual-NIC VMs that each includes a first NIC or virtual NIC (“VNIC”) 122a, 122b, or 122n (corresponding to each of VMs 118a, 118b, and 118n, respectively; collectively, “NICs or VNICs 122,” “first NICs or VNICs 122,” or “inbound NICs or VNICs 122,” or the like) and second NIC or virtual NIC (“VNIC”) 124a, 124b, or 124n (corresponding to each of VMs 118a, 118b, and 118n, respectively; collectively, “NICs or VNICs 124,” “second NICs or VNICs 124,” or “outbound NICs or VNICs 124,” or the like), this is merely for purposes of illustration and the various embodiments are not so limited. In some cases, all of the VMs 118 among the plurality of VMs 118a-118n are dual-NIC VMs, in which case, the first NICs or VNICs 122 would include NICs or VNICs 122a-122n, while the second NICs or VNICs 124 would include NICs or VNICs 124a-124n. In other cases, some of the VMs 118 among the plurality of VMs 118a-118n are dual-NIC VMs, while other VMs 118 among the plurality of VMs 118a-118n are single-NIC VMs, or the like. Herein, “inbound NIC or VNIC” refers to a NIC or VNIC that primarily transfers data or network traffic into the VM, while “outbound NIC or VNIC” refers to a NIC or VNIC that primarily transfers data or network traffic out of the VM. Such terms, however, do not preclude data or network traffic being transferred out of the VM via the “inbound NIC or VNIC” nor preclude data or network traffic being transferred into the VM via the “outbound NIC or VNIC,” as depicted in FIGS. 1A and 1B by gray long-dashed double-headed arrows. A NIC, as used herein, refers to a computer component that connects a computer to a computer network. Herein, the NICs refer to either physical NICs or physical adapters that connect with virtual NICs (“VNICs”).

In examples, system 100 further includes a destination network address translation (“DNAT”) device 126, a plurality of ports 128a-128d, a multi-tenant firewall 130, and a network address translation (“NAT”) device 132, each of which may be disposed in at least one of the security fabric platform 102 and/or the main server 104. In some examples, system 100 may further include rack switch 136 and one or more security fabric platform worker nodes 144a-144x (collectively, “security fabric platform worker nodes 144,” “worker nodes 144,” or the like), each worker node being disposed on a corresponding server among servers 1-X 146a-146x (collectively, “servers 146” or the like). In some instances, the plurality of ports 128a-128d (collectively, “ports 128” or the like) may include a first port 128a configured to receive data or network traffic from a wide area network (“WAN”) or from a device within a local area network (“LAN”), where the first network 134 may include one of the WAN or the LAN. The plurality of ports 128 may further include a second port 128b configured to transmit data or network traffic to device within the LAN, a third port 128c configured to receive and transmit data or network traffic via the at least one CNI 114 to connect with at least one security fabric platform worker node among the one or more security fabric platform worker nodes 144a-144x via rack switch 136, and a fourth port 128d configured to couple storage system 116 with network storage devices disposed in the LAN (in some cases, via rack switch 136).

In examples, rack switch 136 may be embodied as a top-of-rack switch, a rack-mounted switch, a rack-integrated switch, or some other switch that is disposed on or near an equipment rack on which servers 104 and 146a-146x may be mounted within a central office (“CO”), a data center, a server room, a customer premises, or other facility (not shown). In some examples, rack switch 136 may include a plurality of ports or connectors including a first virtual LAN (“VLAN”) port M1 138a configured to couple with the third port 128c of the security fabric platform 102 and/or the main server 104, a second VLAN port M2 138b configured to couple with the fourth port 128d of the security fabric platform 102, a plurality of first VLAN worker ports W1a-W1x 140a-140x (collectively, “first VLAN worker ports 140,” “VLAN worker ports 140,” or the like), and a plurality of second VLAN worker ports W2a-W2x 142a-142x (collectively, “second VLAN worker ports 142,” “VLAN worker ports 142,” or the like).

In some cases, the rack switch 136 may include a simple server with firewall functionality, VLAN functionality, dynamic host configuration protocol (“DHCP”) functionality, and CNI and storage system ports for the security fabric platform 102 (e.g., VLAN ports 138a and 138b, respectively) and each of the one or more security fabric platform worker nodes 146a-146x (e.g., one of VLAN ports 140a-140x and one of VLAN ports 142a-142x, respectively, for each worker node 146). In some instances, the CNI and storage system ports 128c and 128d (and corresponding VLAN ports 138a and 138b) may be combined as a single port (not shown), although performance degradation may result. In all other cases, the CNI and storage system ports 128c and 128d of security fabric platform 102 or main server 104 (and corresponding VLAN ports 138a and 138b of rack switch) are separate or dedicated ports (e.g., Port 3 128c and Port 4 128d, respectively, such as shown in FIGS. 1A and 1B). Each of the security fabric platform worker nodes 144a-144x may have either one or more VMs 148 or one or more containers 150 hosted thereon. The security fabric platform worker nodes 144a-144x are shown and described in detail below with respect to FIG. 1B. In some examples, each security fabric platform worker node 144a-144x or corresponding server 146a-146x includes first through fourth ports 152a-152d that are similar to ports 128a-128d of the security fabric platform 102 and/or the main server 104. VLAN ports 140a-140x of rack switch 136 connect with the third ports 152c of corresponding worker nodes 146a-146x, via the at least one CNI 114, while VLAN ports 142a-142x of rack switch 136 connect with the fourth ports 152d of corresponding worker nodes 146a-146x for connecting with the storage system 116.

In examples, system 100 further includes a customer portal in network(s) 156. In some examples, system 100 may further include at least one of one or more edge nodes 158, one or more secure access service edge (“SASE”)-based network services 160, and/or network service monitoring system 162, and/or the like, that is disposed in network(s) 164. The one or more SASE-based network services 160 collectively include a set of unified, cloud-based services that integrate software-defined wide area network (“SD-WAN”) functionalities with network service functionalities and network security functionalities. In examples, system 100 further includes at least one customer edge (“CE”) router 166 and/or one or more provider edge (“PE”) routers 168a or 168b, and/or the like. In some examples, system 100 may further include a destination device 170 having or associated with network address 172, and disposed or linked with network(s) 174. In examples, two or more of network(s) 156, 164, and/or 174 may be operated or provided by the same service provider or may be operated or provided by different service providers. In some examples, system 100 may further include a computing system 176 that orchestrates, controls, and/or manages at least one of the security fabric platform 102, the rack switch 136, the workers nodes 146a-146x, and/or the like. The same or different computing system may orchestrates, controls, and/or manages at least one of customer portal 154, SASE-based network services 160, network service monitoring system 162, and/or one or more of the one or more edge nodes 158, the CE router 166, and/or the PE router(s) 168a or 168b, and/or the like. In examples, the computing system may include at least one of an orchestrator, a security fabric platform manager, a server manager, a cloud computing system, or a distributed computing system, and/or the like.

According to some embodiments, network(s) 134, 156, 164, and/or 174 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 134, 156, 164, and/or 174 may include an access network of the service provider (e.g., an Internet service provider (“ISP”)). In another embodiment, the network(s) 134, 156, 164, and/or 174 may include a core network of the service provider and/or the Internet.

In some instances, the destination device 170 may include at least one of a network operations center (“NOC”) computing system or console, a service provider device, and/or a server, each associated with a service provider and/or may include at least one of a requesting device or user device associated with a customer or end-user. In examples, the requesting device or user device may each include, but is not limited to, one of a desktop computer, a laptop computer, a tablet computer, a smart phone, a mobile phone, or any suitable device capable of communicating with CE router 166 via network(s) 174. In some cases, the network(s) 174 either may be any suitable roaming network or may be located at a customer premises (not shown). In some instances, the customer or end-user may include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. In some cases, the customer premises may include, but is not limited to, one of a residential customer premises, a business customer premises, a corporate customer premises, an enterprise customer premises, an education facility customer premises, a medical facility customer premises, or a governmental customer premises, and/or the like.

Referring to the non-limiting example of FIG. 1B, each worker node 144a-144x and corresponding server 146a-146x may be similar, if not identical, to security fabric platform 102 and corresponding main server 104, except that each security fabric platform worker node 144 hosts at least one of one or more single-NIC VMs, one or more dual-NIC VMs, or one or more containers, and in some cases do not include a NAT device (e.g., DNAT device 126 or NAT device 132 as disposed in at least one of the security fabric platform 102 and/or the main server 104 as shown in FIG. 1A, or the like). For worker nodes that host containers rather than VMs, a container engine replaces a VM manager. Each work node 144 among the one or more security fabric platform worker nodes 144a-144x, which are disposed on corresponding one of the one or more servers 146a-146x, may include an OS among OSs 106a-106x, a hypervisor or container orchestrator among hypervisors or container orchestrators 108a-108x, a VM manager (for VM-based worker nodes) or a container engine (for container-based worker nodes) among VM manager and/or container engines 110a-110x, a CNI manager among CNI managers 112a-112x, at least one CNI among CNIs 114a-114x, and a storage system among storage systems 116a-116x. In some examples, a multi-tenant firewall (e.g., multi-tenant firewall 130a of FIG. 1B) may be disposed on at least one worker node among the one or more the security fabric platform worker nodes 144a-144x and/or corresponding at least one server among the one or more servers 146a-146x.

In an example, as shown in FIG. 1B, a VM-based worker node 144a that is disposed on server 146a may include OS 106a, hypervisor or container orchestrator 108a, VM manager 110a, CNI manager 112a, at least one CNI 114a, and storage system 116a. In some cases, the VM-based worker node 144a may include at least one of one or more dual-NIC VMs (e.g., VM 148a) each having a first NIC or VNIC (e.g., NIC or VNIC 178a, or the like) and a second NIC or VNIC (e.g., NIC or VNIC 180a, or the like) and having deployed, instantiated, and/or implemented thereon a VNF (e.g., VNF 176a, or the like), or a one or more single-NIC VMs (e.g., VM 148y) each having a single NIC or VNIC (e.g., NIC or VNIC 178y, or the like) and having deployed, instantiated, and/or implemented thereon a VNF (e.g., VNF 176y, or the like), or the like.

In another example, as shown in FIG. 1B, a container-based worker node 144x that is disposed on server 146x may include OS 106x, hypervisor or container orchestrator 108x, container engine 110x, CNI manager 112x, at least one CNI 114x, and storage system 116x. In some cases, the container-based worker node 144x may include at least one of one or more dual-NIC containers (e.g., container 150z) each having a first NIC or VNIC (e.g., NIC or VNIC 184z, or the like) and a second NIC or VNIC (e.g., NIC or VNIC 186z, or the like) and having deployed, instantiated, and/or implemented thereon a cloud-native network function (“CNF”) (e.g., CNF 182z, or the like), or a one or more single-NIC containers (e.g., container 150a) each having a single NIC or VNIC (e.g., NIC or VNIC 184a, or the like) and having deployed, instantiated, and/or implemented thereon a CNF (e.g., CNF 182a, or the like), or the like. Herein, n or N, x or X, y or Y, and z or Z are non-negative integer numbers that may be either all the same as each other, all different from each other, or some combination of same and different (e.g., one set of two or more having the same values with the others having different values, a plurality of sets of two or more having the same value with the others having different values, etc.).

As used herein, a VM refers to a computer file, software, or virtual computer system that emulates functionality of a physical computer, while a container refers to a lightweight, stand-alone, executable software code package that contains an application's code, its libraries, configuration files, and other dependencies and components necessary to operate the application. Where a VM includes VM image files that contain the VM's own individual OS that is configured to run on a host OS (e.g., host OS 106, or the like), a container virtualizes the OS and includes (read-only) container images (or files containing the necessary components and resources) so that its single application can run independently on any platform. As used herein, a network function (“NF”) refers to a basic unit in a network architecture having set external interfaces and functional behavior, including, for example, a network node or a physical appliance, such as a firewall, a switch, a load balancer, an area network optimizer, etc. A VNF, as used herein, refers to a software implementation of an NF that is deployable on virtual resources, such as VMs, and that separate each function from the underlying hardware or physical environment.

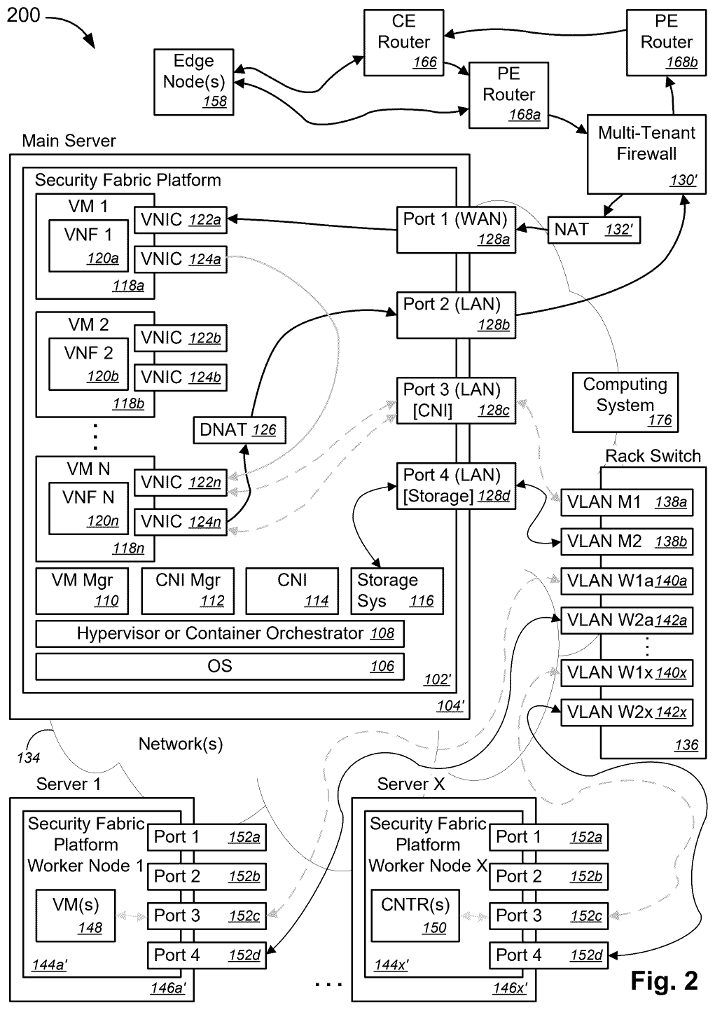

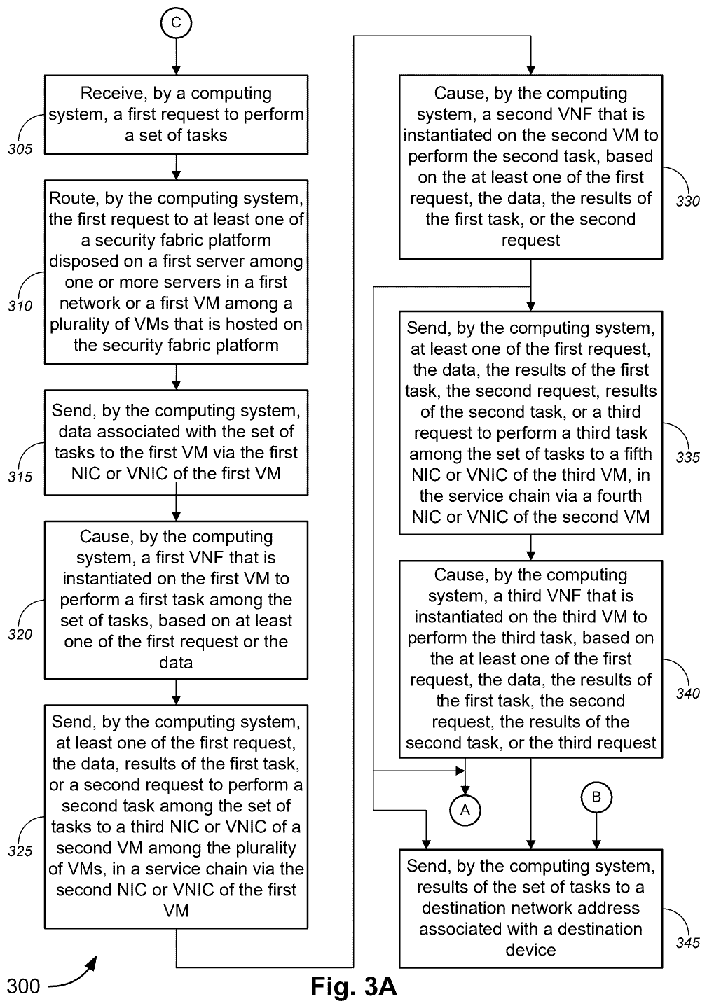

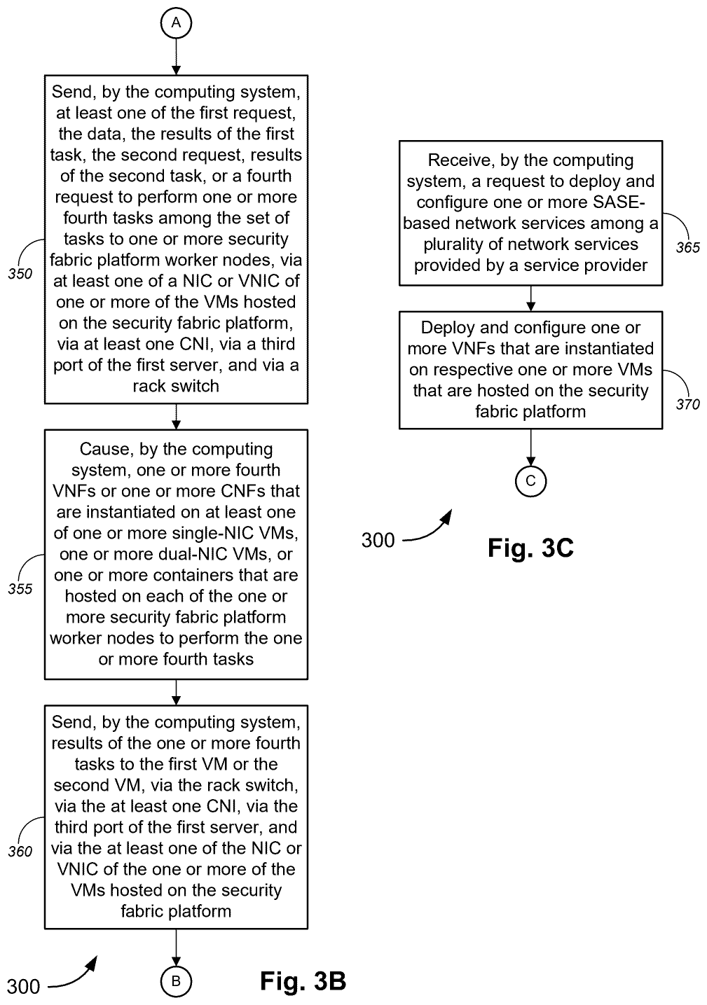

In operation, at least one of security fabric platform 102, OS or host OS 106, hypervisor or container orchestrator 108, VM manager 110, CNI manager 112, and/or computing system 176 (collectively, “computing system”) may perform methods for implementing security fabric platform network services architecture and functionalities, as described in detail with respect to FIGS. 2-5. An alternative example system 200 is described below with respect to FIG. 2, while various example methods 300, 400, and 500 are described below with respect to FIGS. 3A-3C, 4, and 5, respectively, may be applied with respect to the operations of example system 100 of FIG. 1A and 1B and/or example system 200 of FIG. 2.

FIG. 2 depicts a schematic diagram illustrating another example system 200 for implementing security fabric platform network services architecture and functionalities, in accordance with various embodiments. Although not all components are shown in FIG. 2, example system 200 depicts a system that is functionality and structural/architecturally similar, if not identical, to example system 100, except that instead of the multi-tenant firewall and NAT device being disposed within the security fabric platform and/or main server, an external multi-tenant firewall 130′ and NAT device 132′ are used between PE routers 168a and/or 168b and security fabric platform 102′ and/or main server 104′. In some examples, a multi-tenant firewall may be disposed on each of worker nodes 144a′-144x′, similar to worker nodes 144a-144x as shown in FIG. 1B. In other examples, no multi-tenant firewall is disposed on each of the worker nodes 144a′-144x′, similar to the lack of multi-tenant firewall disposed in security fabric platform 102′ of FIG. 2, or the like.

In examples, security fabric platform 102′, main server 104′, OS or host OS 106, hypervisor or container orchestrator 108, VM manager 110, a CNI manager 112, at least one CNI 114, or a storage system 116, VMs 1 through N 118a-118n, VNFs 1 through N 120a-120n, NICs or VNICs 122a-122n and 124a-124n, DNAT device 126, ports 128a-128d, multi-tenant firewall 130′, NAT device 132′, network(s) 134, rack switch 136, VLAN ports 138a, 138b, 140a-140x, and 142a-142x, security fabric platform worker nodes 144a′-144x′, servers 146a′-146x′, VMs 148 and/or containers 150, ports 152a-152d, edge nodes 158, CE router 166, and/or the PE router(s) 168a or 168b of FIG. 2 may be otherwise similar, if not identical, to the security fabric platform 102, main server 104, OS or host OS 106, hypervisor or container orchestrator 108, VM manager 110, a CNI manager 112, at least one CNI 114, or a storage system 116, VMs 1 through N 118a-118n, VNFs 1 through N 120a-120n, NICs or VNICs 122a-122n and 124a-124n, DNAT device 126, ports 128a-128d, multi-tenant firewall 130, NAT device 132, network(s) 134, rack switch 136, VLAN ports 138a, 138b, 140a-140x, and 142a-142x, security fabric platform worker nodes 144a-144x, servers 146a-146x, VMs 148 and/or containers 150, ports 152a-152d, edge nodes 158, CE router 166, and/or the PE router(s) 168a or 168b, respectively, of system 100 of FIGS. 1A and 1B, and the description of these components of system 100 of FIGS. 1A and 1B are similarly applicable to the corresponding components of FIG. 2.

Referring to FIGS. 1A, 1B, and/or 2, in some examples, a request to perform a task may be received by the computing system, in some cases, received within network(s) 134 from destination device 170 or other user device via customer portal 154 and via CE router 166 and PE router 168a. The computing system may then determine how to process the request. In the case that the computing system is an orchestrator (e.g., computing system 176, or the like) within network(s) 134, the computing system may determine whether the security fabric platform 102 includes VMs 118 on which VNFs suitable for performing the requested task has been deployed, instantiated, and/or implemented, and in which of the VMs 118 among the plurality of VMs 118a-118n, which VMs 148 and/or containers 150 in which of one or more worker nodes 144a-144x are applicable to performing the requested task. Based on such determination, the computing system may service chain the determined or identified VMs 118 among the plurality of VMs 118a-118n and the determined or identified VMs 148 and/or containers 150. The request (which may include the data associated with, or needed for performing, the requested task) may be routed through the determined or identified VMs 118, VMs 148 and/or 150, after being monitored and filtered by multi-tenant firewall 130 (or 130′) and routed using NAT device 132 (or 132′) and one or more translation tables, via the corresponding NICs or VNICs among VNICs 122a-122n, 124a-124n, 178, 180, 184, and 186, via VLANs 138-142 of rack switch 136, and via third ports 128c and 152c, and/or the like, prior to being routed using DNAT 126 to destination device 170 at network address 172 via second port 128b, PE router 168b, and CE router 166, or the like.

In an example, if VNF 1 120a and VNF N 120n instantiated on VM 1 118a and VM N 118n of security fabric platform, VNF 1 176a and VNF Y 176y, and CNF 1 182a are determined to be applicable to the requested task, computing system may route the request (and any associated data) from a private IP (“PIP”) device (not shown) that is disposed in network(s) 134 between the PE router 168a and the main server 104, to the first port 128a of security fabric platform 102 and/or main server 104. The request (and the associated data) is monitored and filtered by multi-tenant firewall 130, and, if not filtered out, is routed using NAT 132 using one or more translation tables to NIC or VNIC 122a. In the case that the multi-tenant firewall is external to the security fabric platform 102 and/or server 104, such as in the embodiment of FIG. 2, computing system may route the request (and any associated data) from the PIP device to multi-tenant firewall 130′, and, if not filtered out, is routed using NAT 132 using one or more translation tables to NIC or VNIC 122a, via the first port 128a of security fabric platform 102 and/or main server 104. After receiving the request (and associated data) via NIC or VNIC 122a, VNF 1 120a processes the request and performs at least a first task among a set of tasks in the request, and outputs results of the first task via the service chain from NIC or VNIC 124a to NIC or VNIC 122n of VM N 118n (skipping VMs 2 through N−1 122b-122[n−1]; as shown in FIG. 2). After receiving the request (and associated data) via NIC or VNIC 122n, VNF N 120n processes the request and performs at least a second task among the set of tasks in the request, and outputs results of the second task via the service chain from NIC or VNIC 122n or 124n to NIC or VNIC 178a of VM 148a via at least one CNI 114, via third port 128c, via VLAN ports 138a and 140a of rack switch 136, via third port 152c of worker node 144a and/or server 146a.

After receiving the request (and associated data) via NIC or VNIC 178a of VM 148a hosted on worker node 144a, VNF 1 176a processes the request and performs at least a third task among the set of tasks in the request, and outputs results of the third task via the service chain from NIC or VNIC 180a to NIC or VNIC 178y of VM Y 148y (skipping VMs 2 through Y−1 148b-148[y−1]; as shown in FIG. 1B). After receiving the request (and associated data) via NIC or VNIC 178y, VNF Y 176y processes the request and performs at least a fourth task among the set of tasks in the request, and outputs results of the fourth task via the service chain from NIC or VNIC 178y to NIC or VNIC 184a of container 1 150a hosted on worker node X 144x via at least one CNI 114, via third port 152c of worker node 144a and/or server 146a, via VLAN ports 140a and 140x of rack switch 136, via third port 152c of worker node 144x and/or server 146x. After receiving the request (and associated data) via NIC or VNIC 184a of container 150a hosted on worker node 144x, CNF 1 182a processes the request and performs at least a fifth task among the set of tasks in the request, and outputs results of the fifth task via the service chain from NIC or VNIC 184a back to NIC or VNIC 122n or 124n of VM N 118n, via third port 152c of worker node 144a and/or server 146a, via VLAN ports 140x and 138a of rack switch 136, via third port 128c, and via the at least one CNI 114. The results of the requested task may subsequently be sent from NIC or VNIC 124n of VM N 118n to destination device 170 at network address 172 in network(s) 174, via DNAT device 126, the second port 128b, PE router 168b, and CE router 166.

The path from customer portal 154 or destination device 170 to each of CE router 166, PE router 168a, port 128a, multi-tenant firewall 130, NAT device 132, and NIC or VNIC 122a, in said order, is denoted by solid arrows as depicted in FIG. 1A. Alternatively, the path from CE router 166 to each of PE router 168a, multi-tenant firewall 130′, NAT device 132′, port 128a, and NIC or VNIC 122a, in said order, is denoted by solid arrows as depicted in FIG. 2. The service chain from VM 118a to VM 118n via NIC or VNIC 124a to NIC or VNIC 122n is denoted by gray solid arrows as depicted in FIG. 2. The service chain from VM 118n, to VM 148a, to VM 148y, to container 150a, back to VM 118n, via port 128c, via NICs or VNICs 178a, 180a, 178y, and 184a, via VLAN ports 138a and 140a is denoted by gray long-dashed arrows as depicted in FIG. 1A, 1B, or 2. The path from NIC or VNIC 124n to each of DNAT device 126, multi-tenant firewall 130, port 128b, PE router 168b, CE router 166, and customer portal 154 or destination device 170, in said order, is denoted by solid arrows as depicted in FIG. 1A. Alternatively, the path from NIC or VNIC 124n to each of DNAT device 126, port 128b, multi-tenant firewall 130′, PE router 168b, and CE router 166 (and ultimately customer portal 154 or destination device 170), in said order, is denoted by solid arrows as depicted in FIG. 2.

In an aspect, based on a determination that the VMs of the security fabric platform 102 or 102′ do not have any VNFs deployed, instantiated, and/or implemented thereon or based on a determination that VNFs that have been deployed, instantiated, and/or implemented on the VMs of the security fabric platform 102 or 102′ are not appropriate or applicable to the requested task, the appropriate or applicable VNFs may be ordered, deployed, and configured on one or more VMs among the plurality of VMs of the security fabric platform 102 or 102′. For example, for tasks related to SASE-based tasks, a request to deploy and configure one or more SASE-based network services among a plurality of network services provided by a service provider may be received from customer portal 154 or destination device 170 by the computing system (e.g., computing system 176, or the like). The computing system may autonomously orchestrate deployment and configuration of one or more SASE-based network services VNFs on the one or more VMs. In some embodiments, the one or more SASE-based network services VNFs each includes one of a multi-tenant firewall VNF, a next-generation firewall (“NGFW”) VNF, an Internet and Cloud intelligence platform VNF, a distributed denial of service (“DDoS”) scrubber VNF, or a software-defined wide area network (“SD-WAN”) VNF, and/or the like. The computing system may configure or reconfigure a service chain to span, via a rack switch and via at least one CNI, the one or more VMs of the security fabric platform and at least one of one or more single-NIC VMs, one or more dual-NIC VMs, or one or more containers that are hosted on each of one or more security fabric platform worker nodes. The path from customer portal 154 or destination device 170 to edge node(s) 158 (and thus to SASE-based network services 160 and/or network service monitoring system 162) to PE router 168a, to port 128a, to multi-tenant firewall 130, to NAT device 132, to NIC or VNIC 122a, from NIC or VNIC 124a to NIC or VNIC 122b, from NIC or VNIC 124b to NIC or VNIC 122n, from NIC or VNIC 124n to DNAT device 126, to port 128b, to PE router 168b, to CE router 166, to customer portal 154 or destination device 170 is denoted by solid arrows as depicted in FIG. 1A.

FIGS. 3A-3C (collectively, “Fig. 3”) depict flow diagrams illustrating an example method 300 for implementing security fabric platform network services architecture and functionalities, in accordance with various embodiments. Method 300 of FIG. 3A continues onto FIG. 3B following the circular marker denoted, “A,” and returns to FIG. 3A following the circular marker denoted, “B.” Method 300 of FIG. 3C continues onto FIG. 3A following the circular marker denoted, “C.”

In the non-limiting embodiment of FIG. 3A, method 300, at operation 305, may include receiving, by a computing system, a first request to perform a set of tasks. At operation 310, in response to receiving the first request, method 300 includes routing, by the computing system, the first request to at least one of a security fabric platform disposed on a first server among one or more servers in a first network or a first virtual machine (“VM”) among a plurality of VMs that is hosted on the security fabric platform. The first VM including a first network interface controller (“NIC”) or a first virtual NIC (“VNIC”) and a second NIC or VNIC. Method 300 further includes, at operation 315, sending, by the computing system, data associated with the set of tasks to the first VM via the first NIC or VNIC of the first VM. In some examples, the computing system includes at least one of an orchestrator, a security fabric platform manager, a server manager, a cloud computing system, or a distributed computing system, and/or the like. In examples, the first request includes the data, and routing the first request and sending the data to the first VM are performed together in a single process. In examples, the set of tasks may include at least one of one or more compute tasks, one or more storage tasks, one or more network tasks, one or more network security tasks, or one or more secure access service edge (“SASE”)-based network service tasks, and/or the like. In some examples, the one or more network security tasks and/or the one or more SASE-based network service tasks may include at least one of one or more firewall tasks, one or more multi-tenant firewall tasks, one or more next-generation firewall (“NGFW”) tasks, one or more Internet or Cloud intelligence, monitoring, and/or analytics tasks, one or more distributed denial of service (“DDoS”) monitoring and mitigation tasks, or a software-defined wide area network (“SD-WAN”) tasks, and/or the like.

At operation 320, method 300 includes causing, by the computing system, a first virtual network function (“VNF”) that is instantiated on the first VM to perform a first task among the set of tasks, in some cases, based on at least one of the first request or the data. Method 300 further includes sending, by the computing system, at least one of the first request, the data, results of the first task, or a second request to perform a second task among the set of tasks to a third NIC or VNIC of a second VM among the plurality of VMs, in a service chain via the second NIC or VNIC of the first VM (at operation 325). The method further includes, at operation 330, causing, by the computing system, a second VNF that is instantiated on the second VM to perform the second task, in some cases, based on the at least one of the first request, the data, the results of the first task, or the second request. In some examples, method 300 either may continue onto the process at operation 335, may continue onto the process at operation 345, or may continue onto the process at operation 350 in FIG. 3B following the circular marker denoted, “A,” before returning to the process at operation 345 in FIG. 3A, as indicated by the circular marker denoted, “B.”

In some examples, the plurality of VMs further includes a third VM. In such examples, method 300 further includes, at operation 335, sending, by the computing system, at least one of the first request, the data, the results of the first task, the second request, results of the second task, or a third request to perform a third task among the set of tasks to a fifth NIC or VNIC of the third VM, in the service chain via a fourth NIC or VNIC of the second VM. At operation 340, method 300 further includes causing, by the computing system, a third VNF that is instantiated on the third VM to perform the third task, in some cases, based on the at least one of the first request, the data, the results of the first task, the second request, the results of the second task, or the third request. In examples, the plurality of VMs further includes four or more VMs. In such examples, service chaining may extend in a similar manner as described above with respect to operations 315-340, particularly for VMs having dual-NIC functionality. In such examples, one of the two NICs or VNICs for each VM receives a new request to perform a task using a VNF that is instantiated on said VM, in some cases, based on updated service chain data (including the prior requests to, and/or results of tasks performed by VNFs of, VMs earlier in the service chain, or the like), and the updated service chain data may be further updated with results of the current task that is performed by the VNF that is instantiated on said VM. The other of the two NICs or VNICs for said VM sends another new request (along with the further updated service chain data) to the one of the two NICs or VNICs of the next VM in the service chain. And so on. In some instances, so long as a server has the physical or hardware resources to support a set of VMs, any suitable number of VMs may be hosted on the server, with each such VM being either a single-NIC VM or a dual-NIC VM, or the like. In some cases, a mix of single-NIC VMs and dual-NIC VMs may be implemented. In other cases, all VMs hosted on the server may be one of single-NIC VMS or dual-NIC VMs.

In some examples, method 300 either may continue onto the process at operation 345 or may continue onto the process at operation 350 in FIG. 3B following the circular marker denoted, “A,” before returning to the process at operation 345 in FIG. 3A, as indicated by the circular marker denoted, “B.”

At operation 350 in FIG. 3B (following the circular marker denoted, “A,” in FIG. 3A), method 300 may include sending, by the computing system, at least one of the first request, the data, the results of the first task, the second request, results of the second task, or a fourth request to perform one or more fourth tasks among the set of tasks to one or more security fabric platform worker nodes. In some cases, the at least one of the first request, the data, the results of the first task, the second request, results of the second task, or the fourth request may be sent via at least one of a NIC or VNIC of one or more of the VMs hosted on the security fabric platform (e.g., via at least one of the second NIC or VNIC of the first VM, the third or fourth NIC or VNIC of the second VM, and/or the fifth or sixth NIC or VNIC of the third VM, or the like), via at least one container network interface (“CNI”), via a third port of the first server, and via a rack switch. Method 300 further includes, at operation 355, causing, by the computing system, one or more fourth VNFs or one or more cloud-native network functions (“CNFs”), which are instantiated on at least one of one or more single-NIC VMs, one or more dual-NIC VMs, or one or more containers that are hosted on each of the one or more security fabric platform worker nodes, to perform the one or more fourth tasks. VNFs are configured to be instantiated or implemented on VMs, while CNFs are configured to be instantiated or implemented on containers, where CNFs are cloud-native VNFs configured for operating in cloud environments.

Method 300 further includes sending, by the computing system, results of the one or more fourth tasks to one or more of the first VM, the second VM, or the third VM, via the rack switch, via the at least one CNI, via the third port of the first server, and via the at least one of the NIC or VNIC of the one or more of the VMs hosted on the security fabric platform (at operation 360). In some cases, sending the results of the set of tasks includes sending, by the computing system, at least one of the results of the first task, the results of the second task, or results of the one or more fourth tasks to the destination network, via a fourth NIC or VNIC of the second VM. In some instances, the service chain is configured or reconfigured to span any of the one or more security fabric platform worker nodes via the rack switch and via the CNI, where one or more VNFs or one or more CNFs are deployed on the one or more security fabric platform worker nodes. Method 300 may return to the process at operation 345 in FIG. 3A following the circular marker denoted, “B.”

Turning back to FIG. 3A, method 335, at operation 345, includes sending, by the computing system, results of the set of tasks to a destination network address associated with a destination device. In examples, sending the results of the set of tasks includes sending, by the computing system, at least one of the results of the first task, the results of the second task, results of the third task (if applicable), or results of the one or more fourth tasks (if applicable), and/or the like, to the destination network address, via an outbound NIC or VNIC of the last VM in the service chain within the security fabric platform (e.g., via the fourth NIC or VNIC of the second VM, via the sixth NIC or VNIC of the third VM, or via the other of the two NICs or VNICs of one of the subsequent VMs, or the like).

In some examples, where there are three VMs hosted on the security fabric platform, where each VM is a dual-NIC VM, the service chain within the security fabric platform may span all three VMs, in which case the service chain may start via the first NIC or VNIC of the first VM, through the first VM (in which the first VNF is implemented), via the second NIC or VNIC of the first VM, via the third NIC or VNIC of the second VM, through the second VM (in which the second VNF is implemented), via the fourth NIC or VNIC of the second VM, via the fifth NIC or VNIC of the third VM, through the third VM (in which the third VNF is implemented), and via the sixth NIC or VNIC of the third VM. In other examples, where there are three VMs hosted on the security fabric platform, where each VM is a dual-NIC VM, the service chain within the security fabric platform may span only the first two VMs, in which case the service chain may start via the first NIC or VNIC of the first VM, through the first VM (in which the first VNF is implemented), via the second NIC or VNIC of the first VM, via the third NIC or VNIC of the second VM, through the second VM (in which the second VNF is implemented), and via the fourth NIC or VNIC of the second VM. In the case that the service chain extends through one or more security fabric platform worker nodes, via the at least one CNI via the rack switch, and via through the third port of the first server (or main server), the service chain may further extend from one of the NICs or VNICs of one or more of the second through last VMs in the service chain within the security fabric platform through the third port of the first server (and via the at least one CNI and via the rack switch) to the one or more security fabric platform worker nodes and back to said one of the NICs or VNICs of the one or more of the second through last VMs in the service chain within the security fabric platform prior to sending the results of the set of tasks to the destination network address (at operation 345).

In some embodiments, the first request is received by a firewall. In examples, the first request is routed directly from the firewall to the at least one of the security fabric platform or the first VM, using a network address translation (“NAT”) device and one or more translation tables. In an example, the firewall and the NAT device are part of at least one of the security fabric platform or the first server. In some examples, the first request is received at a first port of the first server. In response to the firewall allowing the first request to pass to the first VM, the NAT device routes the first request from the firewall to the first VM. The results of the set of tasks are sent to the destination network address over the first network and a second network via a second port of the first server, in some cases, based on a network translation of the destination network address. In another example, the firewall and the NAT device are part of the first network yet external to the first server. In examples, the NAT device routes the first request from the firewall to the at least one of the security fabric platform or the first VM via a first port of the first server. The results of the set of tasks are sent to the destination network address over the first network and a second network via the second port of the second server and via the firewall, in some cases, based on a network translation of the destination network address by the NAT device. In examples, the firewall is a multi-tenant firewall. The multi-tenant firewall is configured to block bad actor IP addresses that are contained in a list that is compiled in a threat feed that is created and collected by a rapid threat defense service system.

In some examples, at least one of the first VNF, the second VNF, the third VNF, and/or one or more of the fourth VNFs are SASE-based network services VNFs. With reference to the non-limiting example of FIG. 3C, method 300 further includes, at operation 365, receiving a request to deploy and configure one or more SASE-based network services among a plurality of network services provided by a service provider. At operation 370, in response to receiving the request to deploy and configure the one or more SASE-based network services VNFs, deploying and configuring one or more VNFs that are instantiated on respective one or more VMs that are hosted on the security fabric platform (e.g., at least one of the first VNF, the second VNF, the third VNF, and/or a subsequent VNF that are instantiated on the respective first VM, second VM, third VM, and/or subsequent VM that is hosted on the security fabric platform, or the like). In examples, the at least one of the first VNF, the second VNF, the third VNF, and/or a subsequent VNF is among a plurality of VNFs. In some cases, the plurality of VNFs each includes one of a multi-tenant firewall VNF, a NGFW VNF, an Internet and Cloud intelligence platform VNF, a DDoS scrubber VNF, or a SD-WAN VNF, and/or the like. In some instances, the security fabric platform is deployed in one of a cloud environment, a data center, or physical equipment disposed at customer premises, and/or the like.

Method 300 of FIG. 3C continues onto the process at operation 305 in FIG. 3A following the circular marker denoted, “C.” The process may subsequently proceed as described above, and shown, with respect to at least some of operations 305-360 of method 300 in FIGS. 3A and 3B.

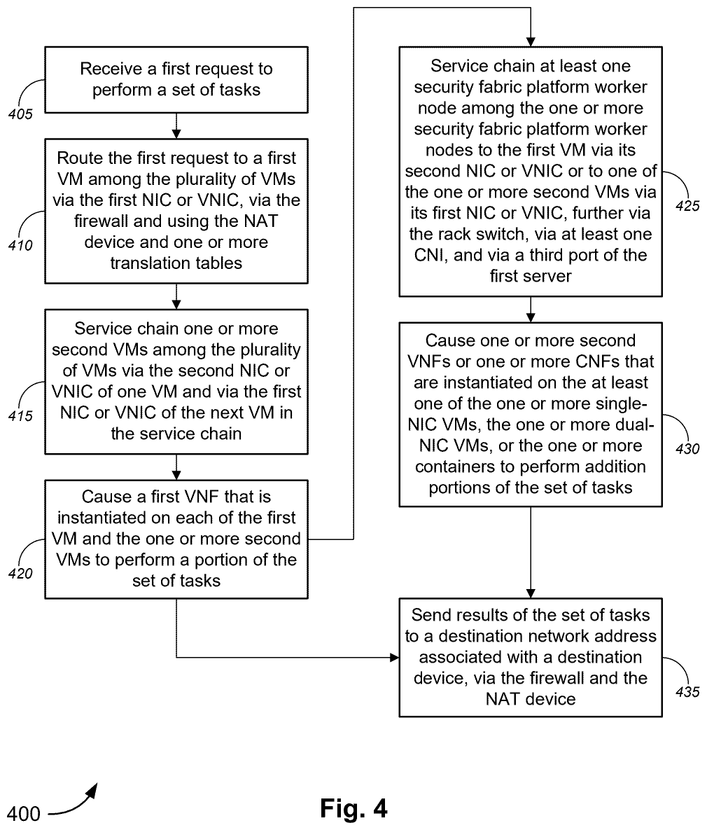

FIG. 4 depicts a flow diagram illustrating another example method 400 for implementing security fabric platform network services architecture and functionalities, in accordance with various embodiments. For the processes of FIG. 4, a system may be used that includes a multi-tenant firewall configured to monitor and filter network traffic; a NAT device configured to map an IP address space into another by modifying network address information in the IP header of packets while the packets pass through the NAT device; a security fabric platform disposed on a first server among one or more servers in a first network; and a computing system configured to perform one or more operations corresponding to the processes of method 400, as described below. The security fabric platform includes a plurality of VMs that is hosted on the security fabric platform, at least one VM among the plurality of VMs includes a first NIC or VNIC and a second NIC or VNIC.

In the non-limiting embodiment of FIG. 4, method 400, at operation 405, may include receiving a first request to perform a set of tasks. In examples, the first request includes data associated with the set of tasks. At operation 410, method 400, in response to receiving the first request, may include routing the first request to a first VM among the plurality of VMs via the first NIC or VNIC, via the firewall and using the NAT device and one or more translation tables. Method 400 may further include, at operation 415, service chaining one or more second VMs among the plurality of VMs via the second NIC or VNIC of one VM and via the first NIC or VNIC of the next VM in the service chain. Method 400 may further include causing a first VNF that is instantiated on each of the first VM and the one or more second VMs to perform a portion of the set of tasks (at operation 420). Method 400 either may continue onto the process at operation 425 or may continue onto the process at operation 435.

In examples, the system further includes a rack switch and one or more security fabric platform worker nodes. Each security fabric platform worker node is disposed on a second server among the one or more servers in the first network. In some instances, each security fabric platform worker node hosts at least one of one or more single-NIC VMs, one or more dual-NIC VMs, or one or more containers, and/or the like. In some examples, method 400 further includes, at operation 425, service chaining at least one security fabric platform worker node among the one or more security fabric platform worker nodes to the first VM via its second NIC or VNIC or to one of the one or more second VMs via its first NIC or VNIC, further via the rack switch, via at least one CNI, and via a third port of the first server. Method 400, at operation 430, further includes causing one or more second VNFs or one or more CNFs that are instantiated on the at least one of the one or more single-NIC VMs, the one or more dual-NIC VMs, or the one or more containers to perform addition portions of the set of tasks. Method 400 may continue onto the process at operation 435.

At operation 435, method 400 may further include sending results of the set of tasks to a destination network address associated with a destination device, via the firewall and the NAT device. In an example, sending the results of the set of tasks includes sending results of each of the first VNFs that are hosted on respective first VM and/or one or more second VMs in the service chain within the security fabric platform [collectively, “security fabric platform service chain VNF results”]. In another example, sending the results of the set of tasks includes sending the security fabric platform service chain VNF results as well as results of the additional portions of the set of tasks performed by the one or more second VNFs or the one or more CNFs of the one or more security fabric platform worker nodes. For the latter, the results of the additional portions of the set of tasks may be sent to the first VM and/or the one of the one or more second VMs, via the rack switch, via the at least one CNI, via the third port of the first server, and via the second NIC or VNIC of the first VM or the first NIC or VNIC of the one of the one or more second VMs, prior to sending the results of the set of tasks to the destination network address at operation 435.

In an example, the firewall and the NAT device are part of at least one of the security fabric platform or the first server. In some instances, the first request is received at a first port of the first server. In some cases, in response to the firewall allowing the first request to pass to the first VM, the NAT device routes the first request from the firewall to the first VM. In examples, the results of the set of tasks are sent to the destination network address over the first network and a second network via a second port of the first server, based on a network translation of the destination network address.

In another example, the firewall and the NAT device are part of the first network yet external to the first server. In some instances, the NAT device routes the first request from the firewall to the at least one of the security fabric platform or the first VM via a first port of the first server. In some cases, the results of the set of tasks are sent to the destination network address over the first network and a second network via a second port of the second server and via the firewall, based on a network translation of the destination network address by the NAT device.

Method 400 is otherwise similar, if not identical to method 300, and similar descriptions of the processes and components of method 300 are applicable to corresponding processes and components of method 400.

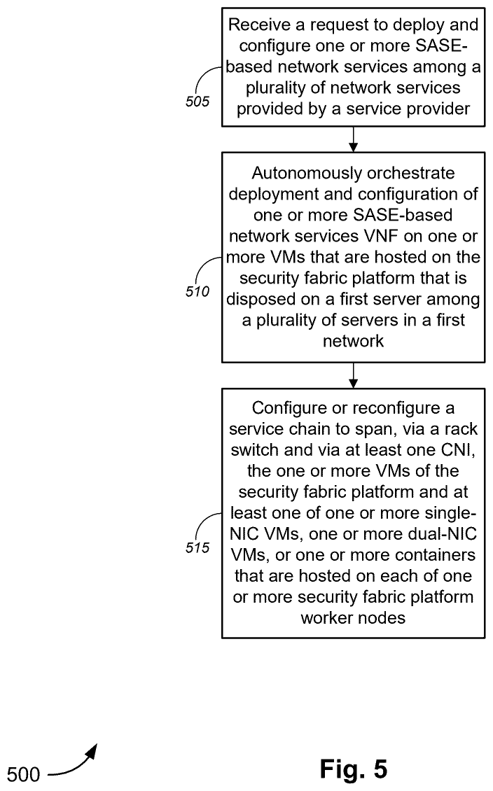

FIG. 5 depicts a flow diagram illustrating yet another example method 500 for implementing security fabric platform network services architecture and functionalities, in accordance with various embodiments.

In the non-limiting embodiment of FIG. 5, method 500, at operation 505, may include receiving a request to deploy and configure one or more SASE-based network services among a plurality of network services provided by a service provider. The one or more SASE-based network services collectively include a set of unified, cloud-based services that integrate SD-WAN functionalities with network service functionalities and network security functionalities. Method 500, at operation 510, further includes autonomously orchestrating deployment and configuration of one or more SASE-based network services VNF on one or more VMs that are hosted on the security fabric platform that is disposed on a first server among a plurality of servers in a first network. In examples, at least one VM among the plurality of VMs includes a first NIC or VNIC and a second NIC or VNIC. In examples, method 400 further includes configuring or reconfiguring a service chain to span, via a rack switch and via at least one CNI, the one or more VMs of the security fabric platform and at least one of one or more single-NIC VMs, one or more dual-NIC VMs, or one or more containers, and/or the like, that are hosted on each of one or more security fabric platform worker nodes.

Method 500 either may continue onto the processes of method 300 or method 400, or is otherwise similar, if not identical to method 300 or method 400, and similar descriptions of the processes and components of method 300 or method 400 are applicable to corresponding processes and components of method 500. Deploying and configuring SASE-based network services is described in greater detail with respect to U.S. patent application Ser. No. 18/302,245 (the “'245 Application”), filed Apr. 18, 2023, by Christopher D. Smith et al. (attorney docket no. 1713-US-U1), entitled, “Secure Access Service Edge (“SASE”),” which claims priority to U.S. Patent Application Ser. No. 63/351,612 (the “'612 Application”), filed Jun. 13, 2022, by Christopher D. Smith et al. (attorney docket no. 1713-US-P1), entitled, “Secure Access Service Edge (“SASE”),” and U.S. Patent Application Ser. No. 63/401,461 (the “'461 Application”), filed Aug. 26, 2022, by Christopher D. Smith et al. (attorney docket no. 1713-US-P2), entitled, “Secure Access Service Edge (“SASE”),” the disclosure of each of which is incorporated herein by reference in its entirety for all purposes.

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100 and 200 of FIGS. 1A-1B and 2, respectively (or components thereof), such methods may also be implemented using any suitable hardware (or software) implementation. Similarly, while each of the systems, examples, or embodiments 100 and 200 of FIGS. 1A-1B and 2, respectively (or components thereof), can operate according to the methods 300, 400, and 500 (e.g., by executing instructions embodied on a computer readable medium), the systems, examples, or embodiments 100 and 200 of FIGS. 1A-1B and 2 can each also operate according to other modes of operation and/or perform other suitable procedures.

### Exemplary System and Hardware Implementation

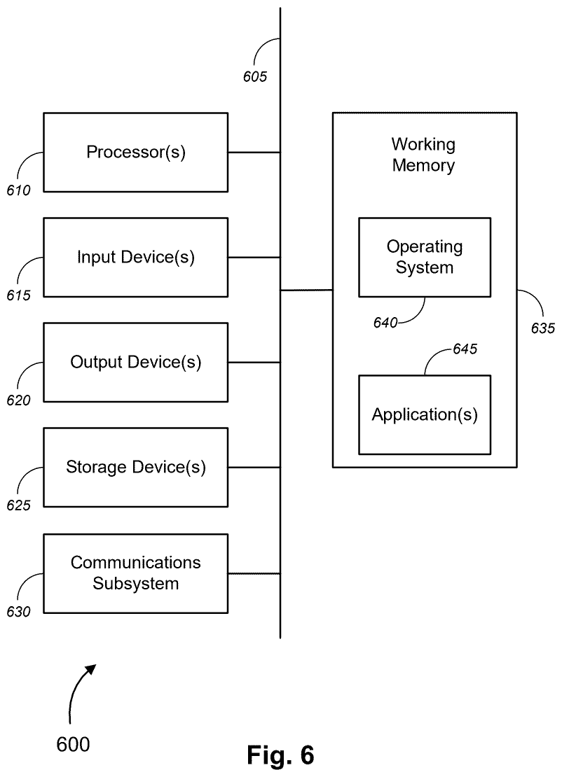

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., security fabric platform 102 or 102′, security fabric platform worker nodes 144a-144x and 144a′-144x′, servers 104, 104′, 146a-146x, and 146a′-146x′, firewall 130 or 130′, rack switch 136, and nodes and routers 158, 166, 168a, and 168b, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., security fabric platform 102 or 102′, security fabric platform worker nodes 144a-144x and 144a′-144x′, servers 104, 104′, 146a-146x, and 146a′-146x′, firewall 130 or 130′, rack switch 136, and nodes and routers 158, 166, 168a, and 168b, etc.), described above with respect to FIGS. 1-5—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infrared communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, a first request to perform a set of tasks;
in response to receiving the first request, routing, by the computing system, the first request to at least one of a security fabric platform disposed on a first server among one or more servers in a first network or a first virtual machine (“VM”) among a plurality of VMs that is hosted on the security fabric platform, the first VM including a first network interface controller (“NIC”) or a first virtual NIC (“VNIC”) and a second NIC or VNIC;
sending, by the computing system, data associated with the set of tasks to the first VM via the first NIC or VNIC of the first VM;
causing, by the computing system, a first virtual network function (“VNF”) that is instantiated on the first VM to perform a first task among the set of tasks, based on at least one of the first request or the data;
sending, by the computing system, at least one of the first request, the data, results of the first task, or a second request to perform a second task among the set of tasks to a third NIC or VNIC of a second VM among the plurality of VMs, in a service chain via the second NIC or VNIC of the first VM;
causing, by the computing system, a second VNF that is instantiated on the second VM to perform the second task, based on the at least one of the first request, the data, the results of the first task, or the second request; and
sending, by the computing system, results of the set of tasks to a destination network address associated with a destination device.

2. The method of claim 1, wherein the first request includes the data, and wherein routing the first request and sending the data to the first VM are performed together in a single process.

3. The method of claim 1, wherein the first request is received by a firewall, wherein the first request is routed directly from the firewall to the at least one of the security fabric platform or the first VM, using a network address translation (“NAT”) device and one or more translation tables.

4. The method of claim 3, wherein the firewall and the NAT device are part of at least one of the security fabric platform or the first server, wherein the first request is received at a first port of the first server, wherein, in response to the firewall allowing the first request to pass to the first VM, the NAT device routes the first request from the firewall to the first VM, wherein the results of the set of tasks are sent to the destination network address over the first network and a second network via a second port of the first server, based on a network translation of the destination network address.

5. The method of claim 3, wherein the firewall and the NAT device are part of the first network yet external to the first server, wherein the NAT device routes the first request from the firewall to the at least one of the security fabric platform or the first VM via a first port of the first server, wherein the results of the set of tasks are sent to the destination network address over the first network and a second network via a second port of the second server and via the firewall, based on a network translation of the destination network address by the NAT device.

6. The method of claim 1, wherein the firewall is a multi-tenant firewall, wherein the multi-tenant firewall is configured to block bad actor IP addresses that are contained in a list that is compiled in a threat feed that is created and collected by a rapid threat defense service system.

7. The method of claim 1, wherein the plurality of VMs further includes a third VM, wherein the method further comprises:
sending, by the computing system, at least one of the first request, the data, the results of the first task, the second request, results of the second task, or a third request to perform a third task among the set of tasks to a fifth NIC or VNIC of the third VM, in the service chain via a fourth NIC or VNIC of the second VM;
causing, by the computing system, a third VNF that is instantiated on the third VM to perform the third task, based on the at least one of the first request, the data, the results of the first task, the second request, the results of the second task, or the third request;
wherein sending the results of the set of tasks comprises sending, by the computing system, at least one of the results of the first task, the results of the second task, or results of the third task to the destination network, via a sixth NIC or VNIC of the third VM.

8. The method of claim 1, further comprising:
sending, by the computing system, at least one of the first request, the data, the results of the first task, the second request, results of the second task, or a fourth request to perform one or more fourth tasks among the set of tasks to one or more security fabric platform worker nodes, via at least one of the second NIC or VNIC of the first VM or the third NIC or VNIC of the second VM, via at least one container network interface (“CNI”), via a third port of the first server, and via a rack switch;
causing, by the computing system, one or more fourth VNFs or one or more cloud-native network functions (“CNFs”) that are instantiated on at least one of one or more single-NIC VMs, one or more dual-NIC VMs, or one or more containers that are hosted on each of the one or more security fabric platform worker nodes to perform the one or more fourth tasks;
sending, by the computing system, results of the one or more fourth tasks to the first VM or the second VM, via the rack switch, via the at least one CNI, via the third port of the first server, and via the at least one of the second NIC or VNIC of the first VM or the third NIC or VNIC of the second VM;
wherein sending the results of the set of tasks comprises sending, by the computing system, at least one of the results of the first task, the results of the second task, or results of the one or more fourth tasks to the destination network, via a fourth NIC or VNIC of the second VM.

9. The method of claim 8, wherein the service chain is configured or reconfigured to span any of the one or more security fabric platform worker nodes via the rack switch and via the CNI, wherein one or more VNFs or one or more CNFs are deployed on the one or more security fabric platform worker nodes.

10. The method of claim 1, wherein the first and second VNFs are secure access service edge (“SASE”)-based network services VNFs, wherein the method further comprises:
in response to receiving a request to deploy and configure one or more SASE-based network services among a plurality of network services provided by a service provider, deploying and configuring the first and second VNFs in the respective first and second VMs of the security fabric platform.

11. The method of claim 1, wherein the first and second VNFs are among a plurality of VNFs, wherein the plurality of VNFs each includes one of a multi-tenant firewall VNF, a next-generation firewall (“NGFW”) VNF, an Internet and Cloud intelligence platform VNF, a distributed denial of service (“DDoS”) scrubber VNF, or a software-defined wide area network (“SD-WAN”) VNF.

12. The method of claim 1, wherein the security fabric platform is deployed in one of a cloud environment, a data center, or physical equipment disposed at customer premises.

13. A system, comprising:
a multi-tenant firewall configured to monitor and filter network traffic;
a network address translation (“NAT”) device configured to map an Internet Protocol (“IP”) address space into another by modifying network address information in the IP header of packets while the packets pass through the NAT device;
a security fabric platform disposed on a first server among one or more servers in a first network, the security fabric platform comprising:
a plurality of virtual machines (“VMs”) that is hosted on the security fabric platform, at least one VM among the plurality of VMs includes a first network interface controller (“NIC”) or a first virtual NIC (“VNIC”) and a second NIC or VNIC; and
a computing system configured to perform one or more operations, the one or more operations including:
receiving a first request to perform a set of tasks, the first request including data associated with the set of tasks;
in response to receiving the first request, routing the first request to a first VM among the plurality of VMs via the first NIC or VNIC, via the firewall and using the NAT device and one or more translation tables;
service chaining one or more second VMs among the plurality of VMs via the second NIC or VNIC of one VM and via the first NIC or VNIC of the next VM in the service chain;
causing a first virtual network function (“VNF”) that is instantiated on each of the first VM and the one or more second VMs to perform a portion of the set of tasks; and
sending results of the set of tasks to a destination network address associated with a destination device, via the firewall and the NAT device.

14. The system of claim 13, wherein the computing system comprises at least one of an orchestrator, a security fabric platform manager, a server manager, a cloud computing system, or a distributed computing system.

15. The system of claim 13, wherein the firewall and the NAT device are part of at least one of the security fabric platform or the first server, wherein the first request is received at a first port of the first server, wherein, in response to the firewall allowing the first request to pass to the first VM, the NAT device routes the first request from the firewall to the first VM, wherein the results of the set of tasks are sent to the destination network address over the first network and a second network via a second port of the first server, based on a network translation of the destination network address.

16. The system of claim 13, wherein the firewall and the NAT device are part of the first network yet external to the first server, wherein the NAT device routes the first request from the firewall to the at least one of the security fabric platform or the first VM via a first port of the first server, wherein the results of the set of tasks are sent to the destination network address over the first network and a second network via a second port of the second server and via the firewall, based on a network translation of the destination network address by the NAT device.

17. The system of claim 13, further comprising:
a rack switch; and
one or more security fabric platform worker nodes, each security fabric platform worker node being disposed on a second server among the one or more servers in the first network, each security fabric platform worker node hosting at least one of one or more single-NIC VMs, one or more dual-NIC VMs, or one or more containers;
wherein the one or more operations further include:
service chaining at least one security fabric platform worker node among the one or more security fabric platform worker nodes to the first VM via its second NIC or VNIC or to one of the one or more second VMs via its first NIC or VNIC, further via the rack switch, via at least one container network interface (“CNI”), and via a third port of the first server;
causing one or more second VNFs or one or more cloud-native network functions (“CNFs”) that are instantiated on the at least one of the one or more single-NIC VMs, the one or more dual-NIC VMs, or the one or more containers to perform addition portions of the set of tasks; and
sending results of the additional portions of the set of tasks to the first VM or the one of the one or more second VMs, via the rack switch, via the at least one CNI, via the third port of the first server, and via the second NIC or VNIC of the first VM or the first NIC or VNIC of the one of the one or more second VMs.

18. A computer-implemented method, comprising:
receiving a request to deploy and configure one or more secure access service edge (“SASE”)-based network services among a plurality of network services provided by a service provider, the one or more SASE-based network services collectively comprising a set of unified, cloud-based services that integrate software-defined wide area network (“SD-WAN”) functionalities with network service functionalities and network security functionalities; and
autonomously orchestrating deployment and configuration of one or more SASE-based network services virtual network function (“VNF”) on one or more virtual machines (“VMs”) that are hosted on the security fabric platform that is disposed on a first server among a plurality of servers in a first network, at least one VM among the plurality of VMs includes a first network interface controller (“NIC”) or a first virtual NIC (“VNIC”) and a second NIC or VNIC.

19. The computer-implemented method of claim 18, wherein the one or more SASE-based network services VNFs each includes one of a multi-tenant firewall VNF, a next-generation firewall (“NGFW”) VNF, an Internet and Cloud intelligence platform VNF, a distributed denial of service (“DDoS”) scrubber VNF, or a software-defined wide area network (“SD-WAN”) VNF.

20. The computer-implemented method of claim 18, further comprising:
configuring or reconfiguring a service chain to span, via a rack switch and via at least one container network interface (“CNI”), the one or more VMs of the security fabric platform and at least one of one or more single-NIC VMs, one or more dual-NIC VMs, or one or more containers that are hosted on each of one or more security fabric platform worker nodes.
